(19) United States
(12) Patent Application Publication
(10) Pub. No.: US 2026/0341975 A1
(43) Pub. Date: Oct. 29, 2026

(54) RADIATOR, ANTENNA AS WELL AS A DEVICE

(71) Applicant: Telefonaktiebolaget LM Ericsson (publ), Stockholm (SE)

(72) Inventor: Shousheng HE, Södra Sandby (SE)

(21) Appl. No.: 19/104,862

(22) PCT Filed: Aug. 25, 2022
(86) PCT No.: PCT/EP2022/073660

§ 371 Date: Feb. 19, 2025

(51) Int. Cl. H01Q 21/10; H01Q 1/27; H01Q 1/42

(52) U.S. Cl. CPC H01Q 21/10; H01Q 1/273; H01Q 1/422

(57) ABSTRACT

A radiator has a plurality of radiation lines wherein each radiation line comprises a shielded conductor and an exposed conductor. The shielded conductor and the exposed conductor of each radiation line extend parallel to one another, the exposed conductor surrounding the shielded conductor The radiation lines are arranged parallel to one another. The shielded conductor and the exposed conductor of the same radiation line are electrically insulated from each other at least between a first end and a second end of the radiation line. The shielded conductor of one of the radiation lines is electrically connected to the exposed conductor of at least one of the other radiation lines by a bridge

Further, an antenna and a device are shown.

### TECHNICAL FIELD

The invention relates to a radiator, an antenna as well as a device.

### BACKGROUND

The miniaturization of wirelessly connected electrical devices advances so that also the demands on antennas increase. Antennas and with that the radiators have to become smaller and more cost-efficient. Small antennas are desirable in a wide range of use cases. For example, in applications with very miniaturized devices, e.g. in the field of sensors implanted in the human or animal body, e.g. subcutaneous sensors, small antennas are needed even if the frequency of the RF is not very high, due to the need for skin penetration, for example. When the dimension of the antenna is much smaller than the wavelength of the RF signal, the antenna is classified as electrically short.

It is known to realize electrically short antenna with small loops. To improve the performance of a small loop antenna, a ferrite core is often used. In such antennas the length of the ferrite core is much larger than its diameter and the coil length of the antenna is much shorter than the ferrite core. Even though such antennas may be much smaller than the wavelength of the electromagnetic radiation they are supposed to receive and transmit, such electrically short antennas do work for electromagnetic radiation having a propagation direction perpendicular to the axis of the loop antenna and the ferrite core.

The effectiveness of the ferrite core antenna is often explained with a theory that the magnetic flux being concentrated by the ferrite core.

Due to the need for a mechanically fragile ferrite core, such small loop antennas cannot be manufactured efficiently, let alone integrated with microfabrication and nanofabrication techniques that are used to build integrated circuits.

### SUMMARY

Thus, there is a need to provide an electrically short antenna that can be manufactured very cost efficiently.

For this purpose, a radiator comprising a plurality of radiation lines is provided, wherein each radiation line comprises a shielded conductor and an exposed conductor. The shielded conductor and the exposed conductor of each radiation line extend parallel to one another in a longitudinal direction of the radiation line, the exposed conductor surrounding the shielded conductor in a circumferential direction of the radiation line. The radiation lines are arranged parallel to one another with respect to their longitudinal direction and have a first end and a second end in the longitudinal direction. The shielded conductor and the exposed conductor of the same radiation line are electrically insulated from each other at least between the first end and the second end. The shielded conductor of one of the radiation lines is electrically connected to the exposed conductor of at least one of the other radiation lines by a bridge.

The inventor has realized that above mentioned theory, that the magnetic flux being concentrated by the ferrite core, does not explain why those extra requirements mentioned above are necessary. The inventor has further realized that the described shielding effect may also be achieved without a ferrite core as the necessary shielding of the shielded conductor may also be achieved by a conducting material for RF signals. Thus, an electrically short antenna without a ferrite core is presented. Further, it has been recognized that this shielding can even be provided by the very conductor that is supposed to receive and transmit the electromagnetic radiation, called exposed conductor. In addition, by providing a plurality of sets of radiation lines comprising a shielded conductor and an exposed conductor next to each other, the necessary magnitudes for defecting the current induced by the electromagnetic radiation are achieved if the radiation lines are connected properly by the bridges at least one of their ends.

In particular, the radiator comprises a radiation direction, wherein the radiation lines are aligned perpendicular to the radiation direction so that electromagnetic radiation efficiently induces a current in the exposed conductor.

In an embodiment, the radiation lines are provided as a cable having an inner conductor and an outer conductor, wherein the inner conductor forms the shielded conductor and the outer conductor forms the exposed conductor, allowing to provide the radiation lines very cost efficiently.

In another embodiment, the radiator comprises at least one or more of: a dielectric insulating material and a non-dielectric insulating material, and at least one conducting material applied to the insulating material, wherein at least parts of the at least one conducting material form the shielded conductor and the exposed conductor. This way, the radiation lines can be manufactured by microfabrication and nanofabrication techniques.

For a very compact design, the at least one insulating material may comprise two parallel insulating layers, wherein between the insulating layers the at least one conducting material is applied forming the shielded conductor and wherein on each of the sides of the insulating layers opposite to the shielded conductor, the at least one conducting material is applied forming parts of the exposed conductor.

For example, the insulating layers are different insulating layers of a multilayered printed circuit board so that the radiator can be manufactured using established and cost efficient manufacturing techniques.

In an aspect of the invention, the radiation lines have a length in the longitudinal direction, and the radiation lines are electrically short and/or the radiation lines have the same or different lengths and/or the length or the different lengths are smaller than 1/10, in particular smaller than 1/100 of the wavelength of a carrier frequency the radiator is designed for. Thus, a very small form factor of the radiator is achieved.

In order to provide a versatile antenna, a carrier frequency the radiator is designed for may be at least 20 kHz and/or at most 2 GHz and/or wherein the carrier frequency lies fully or partially within the Industrial, Scientific and Medical band (ISM-band).

To further reduce the magnitude of countercurrents, the bridges may connect the shielded conductor of the one of the radiation lines electrically to the exposed conductor of at least one of the radiation lines being the neighbor or next-neighbor to the one of the radiation lines.

For example, the bridges are provided at the first end and/or the second end of the radiation lines allowing a versatile arrangement of the radiation lines.

In an embodiment of the invention, the bridges connecting radiation lines are located at the first end, in particular located only at the first end, and wherein the shielded conductor of each radiation line is electrically, in particular galvanically, connected to the exposed conductor of the same radiation line at the second end by a shorting contact. This way, the amount of bridged between the radiation lines can be minimized.

For example, the exposed conductor of a first one of the radiation lines and the shielded conductor of a last one of the radiation lines each provide a connection for feeding the radiator and/or receiving from the radiator, yielding a simple wiring of the radiator.

In another embodiment, for connecting one of the radiation lines with another one, in particular a neighboring one of the radiation lines, two bridges are provided both at the first end or both at the second end, electrically connecting the shielded conductor to the exposed conductor of the other radiation line and electrically connecting the exposed conductor to the shielded conductor of the other radiation line, respectively. This way, the first radiation line is the beginning and end of the circuit of the radiator.

The bridges may be located at the first ends and at the second ends in alternating fashion.

For example, the exposed conductor and the shielded conductor of a first one of the radiation lines provide connections for feeding the radiator and/or receiving from the radiator, allowing the connections to be very close together.

For a simple termination, the exposed conductor and the shielded conductor of a last one of the radiation lines are electrically, in particular galvanically, connected by a shorting contact. The shorting contact may be at the end opposite to the bridge.

For above mentioned purpose, an antenna is provided comprising at least one radiator as described above.

The features and advantages discussed with respect to the radiator also apply to the antenna and vice versa.

For providing a dual polarized antenna, the antenna may comprise at least two radiators as discussed above, wherein the longitudinal directions of the radiation lines of the at least two radiators are oriented at an angle, in particular wherein the longitudinal directions of the two radiators are perpendicular to one another and/or extend in parallel planes.

In an aspect, a tuning capacitor is connected to connections provided by the radiator, the connections being designed for feeding signals to the radiation lines and/or receiving signals from the radiation lines. Further, for above mentioned purpose, a device is provided, in particular a biologically embedded device, a smart device, an electrical magnetic field probe, a wearable or an Internet of Things (IoT) device, comprising an antenna as discussed above, in particular the device being a device for blood sugar monitoring, a hearing aid, a passport, an ID-badge, a subcutaneous identification chip for animals or humans, a subcutaneous diagnosis device, a swallowable diagnosis device or an electrical magnetic field measuring device.

The features and advantages discussed with respect to the radiator and/or antenna also apply to the device and vice versa.

### BRIEF DESCRIPTION OF THE DRAWINGS

Further features and advantages will be apparent from the following description as well as the accompanying drawings, to which reference is made. In the drawings:

FIG. 1 shows a device according to an embodiment of the invention having an antenna according to an embodiment of the invention with a radiator according to an embodiment of the invention,

FIG. 2 shows the antenna of FIG. 1 in an enlarged view schematically,

FIG. 3 shows the first and second ends of two neighboring the radiation lines of the antenna of FIG. 2,

FIG. 4 shows a schematic view of an antenna according to ones of a second embodiment of the invention,

FIG. 5 shows a schematic view of an antenna according to a third embodiment of the invention,

FIG. 6 shows a partial cut of a radiation line of a radiator according to a fourth embodiment of the invention,

FIG. 7 shows an antenna according to a fifth embodiment of the invention schematically,

FIG. 8 shows the first and second ends of two neighboring ones of the radiation lines of the antenna of FIG. 7,

FIG. 9 shows an antenna according to a sixth embodiment of the invention schematically, and

FIG. 10 shows an antenna according to a seventh embodiment of the invention schematically.

### DETAILED DESCRIPTION

The principle of the invention partially lies on a new interpretation how a ferrite core works in a ferrite core small loop antenna.

Assuming that the impinging electromagnetic waves is vertically polarized, the loop may be partitioned into two segments, one at the frontside with respect to the electromagnetic wave, the other at the backside. The electromagnetic wave induces a current at the frontside and at the backside that are both directed in the same spatial direction, i.e. the direction of the electric field.

Electrically, the currents are directed in opposite directions, due to the closed loop design of the antenna. As such, the current induced at the backside might be regarded as a counter current to the current induced at the frontside. Nevertheless, due to the ferrite core inserted into the loop, the backside of the loop is magnetically shielded by the ferrite core. Thus, the current induced in the backside is much smaller than the current induced at the frontside so that this setup can be used to receive (and transmit) electromagnetic waves.

It has been realized that for RF signals, magnetic shielding can be realized by either magnetic or electrical shielding which leads to the new antenna structure for electrically short antennas.

An electrically small or electrically short antenna is an antenna much shorter than the wavelength of the signal it is intended to transmit or receive.

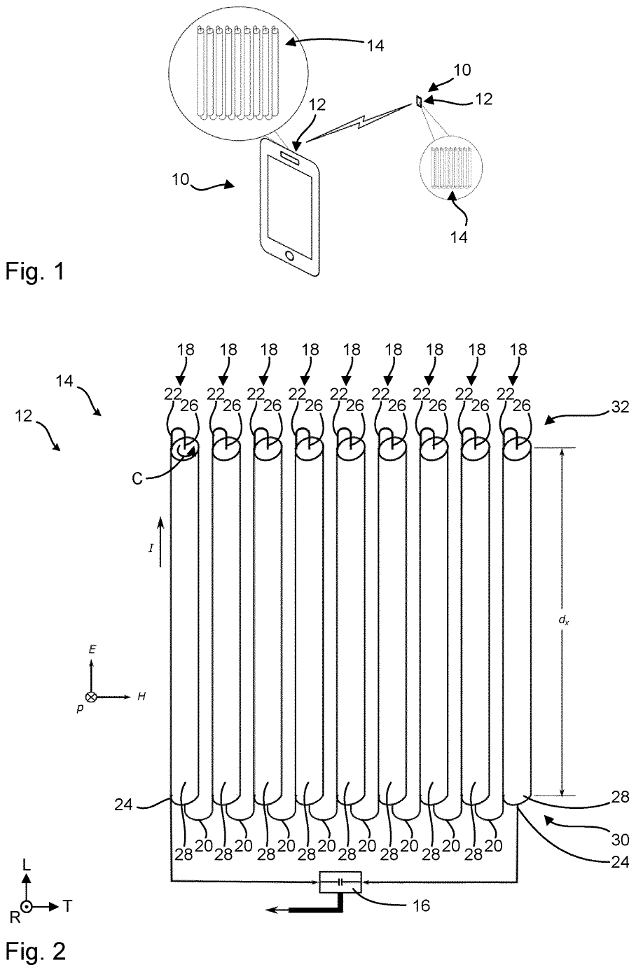

FIG. 1 shows schematically two devices 10 according to the invention both having an antenna 12 according to the invention with a radiator 14 according to the invention.

One of the devices 10 is a smart device, like a smart phone, a tablet or the like. It may as well be a wearable.

The other one of the devices 10 is a biologically embedded device, an electric field probe, a wearable or in Internet of things device (IoT device). This device 10 maybe, for example, a device for blood sugar monitoring, a hearing aid, a passport, and ID badge, a subcutaneous identification chip for animals or humans, a subcutaneous diagnosis device, a swallowable diagnosis device or an electrical magnetic field measuring device.

FIG. 2 shows the antenna 12 schematically in an enlarged view.

The antenna 12 comprises the radiator 14 as well as a tuning capacitor 16.

The tuning capacitor 16 may be regarded as a tuning component having a pure imaginary impedance for tuning the radiator 14.

The antenna 12 is connected to an amplifier, receiver or transceiver (not shown), via the tuning capacitor 16.

The radiator 14 is a radiator 14 for receiving and transmitting electromagnetic radiation. For example, the radiator 14 may be regarded as an RF transceiver radiator.

The radiator 14 has a radiation direction R in which electromagnetic radiation is emitted by the radiator 14 or from which direction electromagnetic radiation may be received by the radiator 14.

Further, the radiator 14 has a carrier frequency being the frequency for which the radiator 14 is designed to receive and emit electromagnetic radiation. The carrier frequency is at least 20 kHz and/or at most 2 GHz. The carrier frequency may lie fully within the industrial, scientific and medical band (ISM-band) or only in parts within the ISM-band.

The radiator 14 comprises a plurality of radiation lines 18, a plurality of bridges 20, a plurality of shorting contacts 22 and two connections 24.

The connections 24 are designed for feeding signals to the radiation lines 18 and receiving signals from the radiation lines 18. The connections 24 are electrically connected to the tuning capacitor 16.

The radiation lines 18 have a longitudinal direction L and a transverse direction T perpendicular to the longitudinal direction L.

The radiation direction R is perpendicular to the longitudinal direction L and the traverse direction T.

If two things are stated as being perpendicular or parallel, within this disclosure this also includes the situations where the two things are “approximately perpendicular” or “approximately parallel”, respectively, if not stated otherwise. Likewise, if stated that two things are approximately perpendicular or parallel, this does not exclude the two things being exactly perpendicular or parallel either. Further, it is assumed that the skilled person would know how to interpret “approximately perpendicular” or “approximately parallel”, and know how far from being exactly perpendicular or parallel the two things can be while still obtaining a same, or sufficiently same, technical effect.

The radiation lines 18 are arranged parallel to each other with respect to the longitudinal direction L. Thus, the radiation lines (18) are arranged on virtual axes in the longitudinal direction L, the virtual axes being non-coincident, i.e. the radiation lines are positioned side by side in a plane perpendicular to the virtual axes.

The radiation lines 18 have a length dx in the longitudinal direction L. In the first embodiment, all of the radiation lines 18 have the same length dx.

The length dx is smaller than 1/10, in particular smaller than 1/100 of the wavelengths of the carrier frequency. The radiation lines 18 are therefore electrically short.

In the traverse direction T, the radiation lines 18 are arranged on a straight line. Thus, the radiation lines 18 lie in a plane. The radiation lines may, in another example, be arranged over a non-flat surface, e.g. a convex or a concave surface.

Each of the radiation lines 18 has a shielded conductor 26 and an exposed conductor 28.

The shielded conductor 26 and the exposed conductor 28 extent in the longitudinal direction L between a first end 30 and a second end 32 of the radiator 14 in the longitudinal direction L.

In particular, in the longitudinal direction L the shielded conductor 26 and/or the exposed conductor 28 extend from the first end fully to the second end 32. Thus, the shielded conductor 26 and the exposed conductors 28 have the length dx in the longitudinal direction L. Thus, also the shielded conductor 26 and the exposed conductors 28 are electrically short.

The shielded conductor 26 is surrounded by the exposed conductor 28 in the circumferential direction C around the longitudinal direction L.

In the shown embodiment, the exposed conductor 28 surrounds the shielded conductor 26 in the circumferential direction C entirely. It is also conceivable, that the exposed conductor 28 does not surround the shielded conductor 26 entirely in the circumferential direction but almost entirely, for example more than 90%, in particular more than 95% of the circumference of the shielded conductor 26.

The shielded conductor 26 and the exposed conductor 28 are electrically insulated from one another between the first end 30 and the second end 32.

Embodiments of the Radiator Does Not Comprise a Ferrite Core

In the first embodiment, each of the radiation lines 18 is formed by a piece of cable having an inner conductor being the shielded conductor 26 and an outer conductor being the exposed conductor 28. However, even though the radiation lines 18 may resemble coaxial cables, it is to be noted that the radiation lines 18 are designed such that they do not support the propagation of electromagnetic waves with wavelengths of the carrier frequency or close to the carrier frequency along the longitudinal direction L. As such, they are not waveguides for electromagnetic wave with the carrier frequency or frequencies close to the carrier frequency.

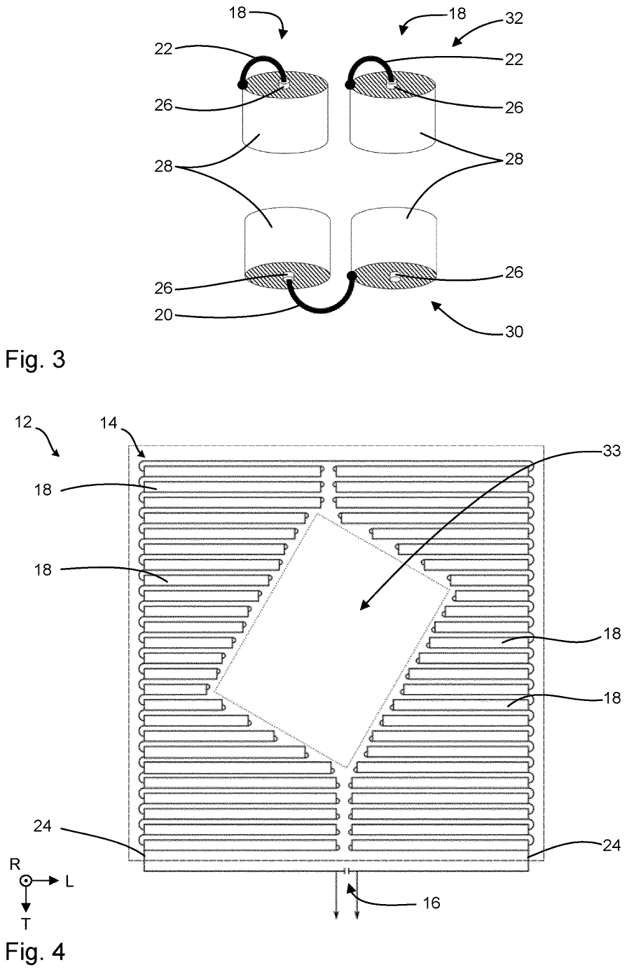

In the first embodiment shown in FIGS. 2 and 3, the bridges 20 are located at the first ends 30 of the radiation lines 18.

The number of bridges 20 at the first ends 30 corresponds to the number of radiation lines minus one. Thus, in the first embodiment, eight bridges 20 are provided at the first ends 30. Further, in the first embodiment, the bridges 20 are located only at the first end 30.

Each of the bridges 20 is electrically connected to the shielded conductor 26 of one of the radiation lines 18 as well as to the exposed conductor 28 of the radiation line 18 being the neighbor of the radiation line 18 whose shielded conductor 26 is connected to the bridge 20.

Within this disclosure, “neighbor” is to be understood such that two radiation lines 18 are neighbors if no intermediate radiation line 18 is present in between them. Likewise, two radiation lines 18 are “next-neighbors” if only one further radiation line 18 is located in between them.

As can best seen in FIG. 3, the bridges 20 connect the shielded conductor 26 of a radiation line 18 with the exposed conductor 28 of the radiation line 18 of the right-hand neighbor.

Thus, each radiation line 18 has a bridge 20 connected to its exposed conductor 28 and another bridge 20 connected to its shielded conductor 26, both at the first end 30.

Exceptions are the first radiation line 18 (at the left-hand side of FIG. 2), i.e. the first one of the radiation lines 18 with respect to the arrangement of the radiation lines 18 in the traverse direction T, and the last radiation line 18 (at the right hand side in FIG. 2), i.e. the last one of the radiation lines 18 with respect to the arrangement of the radiation lines 18 in the traverse direction T.

The first radiation line 18 has only its shielded conductor 26 connected to a bridge 20. The exposed conductor 28 of the first radiation line 18 is not connected to a bridge 20 but provides at the first end 30 one of the connections 24 of the radiator 14.

Likewise, the last radiation line 18 has only its exposed conductor 28 connected to a bridge 20. The shielded conductor 26 is not connected to a bridge 20 but provides at the first end 30 the other one of the connections 24 of the radiator 14.

At the second end 32 of the radiation lines 18, the shorting contacts 22 are located. For each of the radiation lines 18, one shorting contact 22 is provided, wherein each shorting contact 22 electrically connects the shielded conductor 26 with the exposed conductor 28 of the associated radiation line 18.

By virtue of the arrangement and connections between the shielded conductors 26, the exposed conductors 28, the bridges 20 and the shorting contacts 22, the radiator 14 comprises a single electrical circuit, in which the exposed conductors 28 and the shielded conductors 26 of the radiation lines 18 are arranged in alternating fashion. Further, the shielded conductors 26 are shielded from electromagnetic radiation impinging on the radiator 14 the respective exposed conductor 28 so that only the exposed conductors 28 are exposed to the electromagnetic radiation. Therefore, the electromagnetic radiation impinging on the radiator 14 induces a current only in the exposed conductors 28.

Considering electromagnetic radiation propagating in a propagation direction p perpendicular to the drawing plane of FIG. 2 away from the spectator, the electric field E and the magnetic field H of the radiation would be in the longitudinal direction L and the transverse direction T, respectively. As such, the electromagnetic radiation would induce a current I in each of the exposed conductors 28 directed upwards with respect to FIG. 2. It is important to note that the current flow is induced by the electromagnetic radiation in each of the exposed conductors 28 is in the same direction (upwards).

Once generated, due to the shorting contacts 22, the induced current may then flow in the shielded conductor 26 downwards. Because the shielded conductors 26 are shielded from the electromagnetic radiation, the magnitude of the current flowing in the shielded conductor 26 is not decreased by the impinging electromagnetic radiation.

Then, arriving at the at the first end 30 again, the current flows to the exposed conductor 28 of the neighboring radiation line 18 by another bridge 20. The current then flows in the exposed conductor 28 upwards again and its magnitude is even increased as the electromagnetic radiation impinging on the radiator 14 induces a current in the same direction also in the exposed conductor 28 of the neighboring radiation line 18.

In other words, the current induced in any radiation line 18 is enhanced in every following downstream radiation line 18 so that at the latest, in the last radiation line 18 a strong and measurable signal corresponding to that of the impinging electromagnetic radiation is generated. As the electromagnetic radiation does only induce the current in one direction (upwards in FIG. 2), the shielded conductors 26 are used to transfer the current in the opposite direction, in FIG. 2 from the second end 32 to the first end 30, without exposure to the impinging electromagnetic radiation which would decrease the current by inducing a countercurrent.

As the length of the radiation lines 18 is electrically short, phase differences along the radiation lines 18 do not have an adverse effect.

Thus, a whole new type of radiator and thus a whole new type of antenna is provided which is very small and efficient to manufacture.

FIGS. 4 to 10 show further embodiments of the invention corresponding substantially to the first embodiment as discussed above. Thus, in the following, only the differences are discussed and the same and functionally the same components are labeled with the same reference signs.

FIG. 4 shows a second embodiment of an antenna 12 with a second embodiment of the radiator 14.

In this embodiment, not all of the radiation lines 18 are arranged in a single row, i.e. on a straight line, but in two rows.

Both rows have the same number of radiation lines 18 and the radiation line 18 face each other with their second ends 32.

The first ends 30 of the radiation lines 18 of each row are on a straight line so that the whole radiator 14 has a rectangular outer contour.

The length dx of the radiation lines 18 within each row are not the same as can be seen in FIG. 4. Thus, a void 33 or an empty space in the middle of the radiator 14 is provided. In this space, other components of the device 10, like a microchip, may be arranged. Thus, it is possible to arrange the antenna 12 of the radiator 14 very efficiently as it may be adapted around virtually every contour of other components of a device 10.

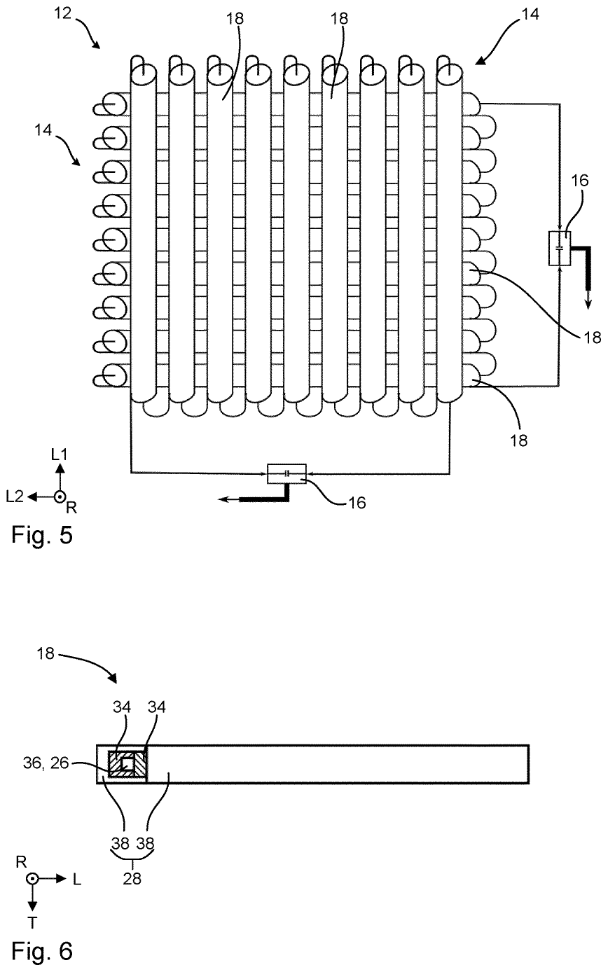

FIG. 5 shows a third embodiment of an antenna 12. In this third embodiment, the antenna 12 has two radiators 14, both of which are designed as explained with respect to FIGS. 2 and 3.

The radiation lines 18 of the two radiators 14 are aligned in two different planes, which are parallel to one another. Thus, the radiation direction R of both radiators 14 is the same.

Further, the longitudinal directions L1, L2 of the two radiators 14 are oriented at an angle larger than 0° with one another (if seen perpendicular to the planes). In the shown embodiment, the longitudinal directions L1, L2 are perpendicular to one another.

The two radiators 14 overlap so that the radiation line 18 form a grid and/or so that the antenna 12 has a squared outer contour.

With the arrangement of this third embodiment, a dual polarized antenna 12 is provided as each one of the radiators 14 receives or transmits electromagnetic radiation with a different polarization but in the same propagation direction p.

FIG. 6 shows a fourth embodiment of the invention, namely a radiation line 18 in a partially cut view.

In the fourth embodiment, the radiator 14 has a layered structure and is, for example, manufactured using microfabrication or nanofabrication techniques.

The shown radiation line 18 comprises two parallel insulating layers 34 of insulating material. The insulating layers 34 may be of a dielectric insulating material or a non-dielectric insulating material. The insulating layers 34 may be made of the same material or of different materials. It is also possible, that one of the insulating materials is a dielectric insulating material and the other insulating material is a non-dielectric insulating material.

To the insulating layers 34, conducting material is applied forming conductors 36, 38. The conductors 36, 38 form the shielded conductor 26 and the exposed conductor 28 of the radiation line 18, at least partially.

For example, the insulating layers 34 may be different insulating layers of a multilayered printed circuit board and the applied conductors 36, 38 may be conducting material applied to one of the insulating layers.

Between the insulating layers 34, an applied conductor 36 is provided by applying the conducting material to a side of one of the insulating layers 34. The applied conductor 36 forms the shielded conductor 26.

On each of the sides of the insulating layers 34 facing away from the applied conductor 36, i.e. on the outer sides, the further conductors 38 are applied. The further conductors 38 are galvanically connected to one another through the insulating layers 34, for example by use of vias (not shown).

The two further applied conductors 38 (together with the galvanic connection) surround the applied conductor 36, i.e. the shielded conductor 26, and thus form the exposed conductor 28.

The shown construction may be repeated transversely of the shown radiation line 18, thus forming a radiator 14 as explained above.

The bridges 20 and shorting contacts 22 may also be formed by the conducting material applied to one or both of the insulating layers 34, optionally by the further use of vias.

This way, a radiator 14 is provided that can be manufactured integrally with electronics of the device 10 thus, drastically reducing costs of the antenna 12 and the device 10.

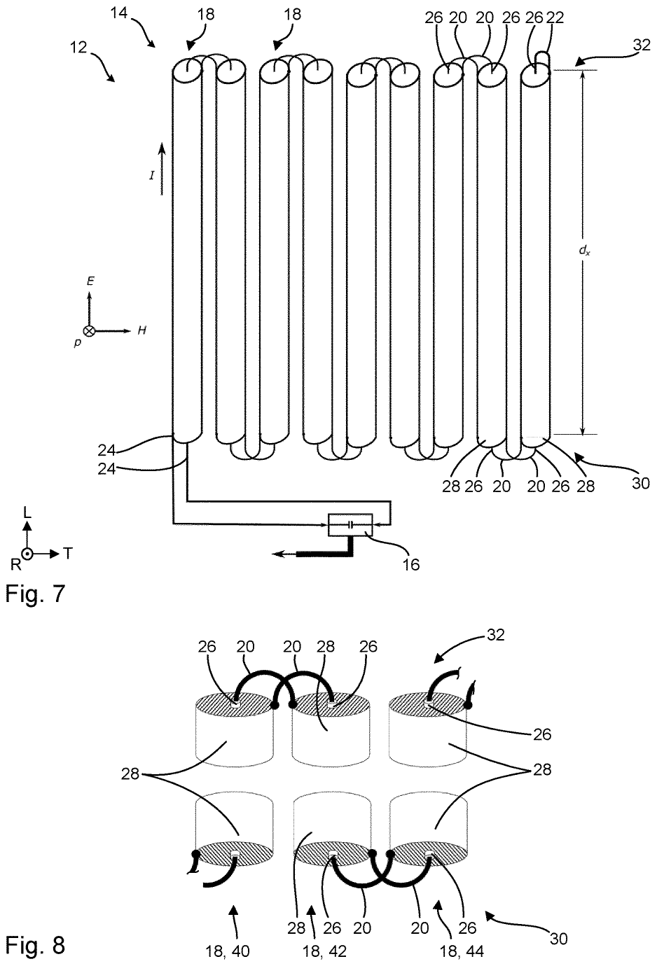

FIGS. 7 and 8 show a third embodiment of the invention. The views of FIGS. 7 and 8 corresponds to the views of FIGS. 2 and 3. The third embodiment differs from the first embodiment in the way that neighboring radiation lines 18 are connected to one another.

In the fifth embodiment, only one shorting contact 22 is provided, namely at the last radiation line 18. At the other radiation lines 18, further bridges 20 are provided at the second ends 32. As with the number of bridges 20 at the first ends 30, the number of bridges 20 at the second ends 32 is the number of radiation lines minus one. In the shown embodiment, eight bridges 20 are provided at the second ends 32.

However, the bridges 20 at the second ends 32 but also at the first ends 30 are arranged differently from the first embodiment.

As best seen in FIG. 8, in the fifth embodiment, two bridges 20 extend in conjunction from the same end 30, 32 of one of the radiation lines 18 to the same side of the neighboring radiation line 18. One of the two bridges 20 electrically connects the shielded conductor 26 of the radiation line 18 with the exposed conductor 28 of the neighboring radiation line 18, and the other one of the bridges 20 connects the exposed conductor 28 of the radiation line 18 with the shielded conductor 26 of the same neighboring radiation line 18.

The neighboring radiation line 18 is in turn electrically connected to its further neighboring radiation line 18 by two further bridges 20 located only at the opposite end 32, 30.

For example starting with the first radiation line 18 in FIG. 7 (left-hand side), the first radiation line 18 provides both connections 24 to the tuning capacitor 16. More precisely, each one of the shielded conductor 26 and the exposed conductor 28 at the first end 30 of the first radiation line 18 form one of the connections 24.

At the second end 32 of the first radiation line 18 (left radiation line 40 in FIG. 8), two bridges 20 are provided, one bridge 20 being connected to the shielded conductor 26, and the other one connected to the exposed conductor 28. The two bridges 20 then extend to the second end 32 of the neighboring radiation line 18 (middle radiation line 42 in FIG. 8) and are connected to the exposed conductor 28 and the shielded conductor 26, respectively. As such, the shielded conductor 26 of the first radiation line 18 is connected to the exposed conductor 28 of the second radiation line 18, and the exposed conductor 28 of the first radiation line 18 is connected to the shielded conductor 26 of the second radiation line 18.

The second radiation line 18 is then connected to its further neighbor (right radiation line 44 in FIG. 8) by two bridges 20 provided only at the first end 30.

Again, one of the bridges 20 connects the shielded conductor 26 of the second radiation line 18 to the exposed conductor 28 of the third radiation line 18, and the second one of the bridges 20 connects the exposed conductor 28 of the second radiation line 18 to the shielded conductor 26 of the third radiation line 18.

Thus, the connection between neighboring radiation lines 18 is either provided only at the first end 30 or only a second end 32, wherein the first end 30 or the second end 32 are used in alternating fashion.

The last radiation line 18 comprises an end 30, 32 which is not connected to a neighboring radiation line 18. At this end, the shorting contact 22 is electrically connecting the shielded conductor 26 with the exposed conductor 28 of the last radiation line 18. In the shown embodiment, the shorting contact 22 is located at the second end 32. But if an even number of radiation lines 18 is used, the shorting contact is located at the first end 30.

Also this way of connecting neighboring radiation lines 18 by the bridges 20 leads to the desired situation in which the current I induced by electromagnetic radiation impinging on the exposed conductors 28 is always directed in the same direction as the current coming from the radiation lines 18 further upstream.

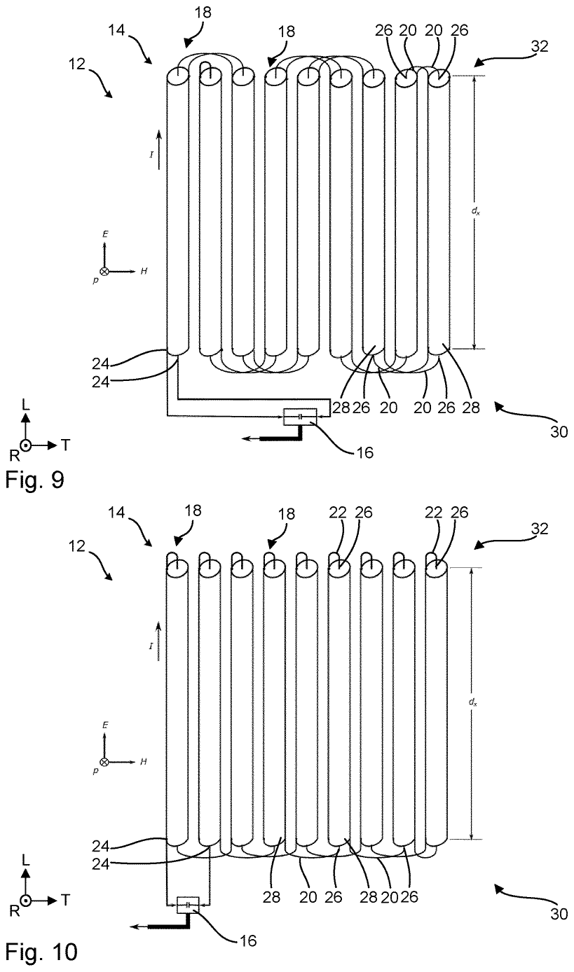

FIG. 9 shows a sixth embodiment of the invention, its view corresponding to the view of FIG. 7.

The sixth embodiment substantially corresponds to the fifth embodiment. In particular, the connection between radiation lines 18 is provided by two bridges 20 located only at the first end 30 or only at the second end 32.

However, the radiation lines 18 are not electrically connected to their neighbors but only to their next-neighbors.

The exception being the last radiation line 18 and the second to last radiation line which are direct neighbors and are connected to one another by two bridges 20, in the shown embodiment only at the second end 32.

The second radiation line 18 then corresponds to the last radiation line 18 of the fifth embodiment. It is thus provided with a shorting contact 22 and it is only connected to one next-neighbor.

The arrangement of the sixth embodiment may be regarded as a modification of the fifth embodiment. The sixth embodiment may be obtained from the fifth embodiment by folding the row of radiation lines 18 after the fourth radiation line 18.

FIG. 10 shows a seventh embodiment of the invention. The view of FIG. 10 corresponds to the view of FIG. 9, wherein the seventh embodiment is based on the first embodiment in the same way as the sixth embodiment is based on the fifth embodiment.

In the seventh embodiment, the radiation lines 18 are connected to one another as explained with respect to the first embodiment, namely the radiation lines 18 having shorting contact 22 at the second ends 32 and bridges at the first ends 30.

However, just as in the sixth embodiment, the radiation lines 18 are not connected to their direct neighbors by the bridge 20 but to the next-neighbors.

This setup of the seventh embodiment has the advantage compared to the first embodiment that the connections 24 are provided by the first radiation line 18 and the second radiation line 18. Thus, the connections 24 are close together, reducing the amount of wiring to reach the tuning capacitor 16.

Again, the seventh embodiment may be obtained by using the first embodiment and folding the row of radiation lines 18 after the fifth radiation line 18.

1. A radiator, comprising a plurality of radiation lines, each radiation line comprising a shielded conductor and an exposed conductor;
the shielded conductor and the exposed conductor of each radiation line extending parallel to one another in a longitudinal direction of the radiation line, the exposed conductor surrounding the shielded conductor in a circumferential direction of the radiation line;
the radiation lines being arranged parallel to one another with respect to their longitudinal direction, and having a first end and a second end in the longitudinal direction;
the shielded conductor and the exposed conductor of the same radiation line being electrically insulated from each other at least between the first end and the second end (32); and
the shielded conductor of one of the radiation lines being electrically connected to the exposed conductor of at least one of the other radiation lines by a bridge.

2. The radiator according to claim 1, wherein the radiator comprises a radiation direction, wherein the radiation lines are aligned perpendicular to the radiation direction.

3. The radiator according to claim 1, wherein the radiation lines are provided as a cable having an inner conductor and an outer conductor, wherein the inner conductor forms the shielded conductor and the outer conductor forms the exposed conductor.

4. The radiator according to claim 1, wherein the radiator comprises:
at least one or more of: a dielectric insulating material and a non-dielectric insulating material; and
at least one conducting material applied to the insulating material, wherein at least parts of the at least one conducting material form the shielded conductor and the exposed conductor.

5. The radiator according to claim 4, wherein the at least one insulating material comprises two parallel insulating layers, wherein between the insulating layers the at least one conducting material is applied forming the shielded conductor and wherein on each of the sides of the insulating layers opposite to the shielded conductor, the at least one conducting material is applied forming parts of the exposed conductor.

6. The radiator according to claim 5, wherein the insulating layers are different insulating layers of a multilayered printed circuit board.

7. The radiator according to claim 1, wherein the radiation lines have a length (dx) in the longitudinal direction, wherein one or more of:
the radiation lines are electrically short;
the radiation lines have the same or different lengths; and
the length (dx) or the different lengths are smaller than 1/100 of the wavelength of a carrier frequency the radiator is designed for.

8. The radiator according to claim 1, wherein one or more of:
a carrier frequency the radiator is designed for is at least 20 kHz;
the carrier frequency the radiator is designed for is at most 2 GHz; and
the carrier frequency lies fully or partially within the Industrial, Scientific and Medical band.

9. The radiator according to claim 1, wherein the bridges electrically connect the shielded conductor of the one of the radiation lines to the exposed conductor of at least one of the radiation lines being the neighbor or next-neighbor to the one of the radiation lines.

10. The radiator according to claim 1, wherein the bridges are provided at the first end and/or the second end of the radiation lines.

11. The radiator according to claim 1, wherein the bridges connecting radiation lines are located at the first end in particular located only at the first end, and wherein the shielded conductor of each radiation line is electrically, galvanically connected to the exposed conductor of the same radiation line at the second end by a shorting contact.

12. The radiator according to claim 11, wherein the exposed conductor of a first one of the radiation lines and the shielded conductor of a last one of the radiation lines each provide a connection for one or both feeding the radiator and receiving from the radiator.

13. The radiator according to claim 1, wherein for connecting one of the radiation lines with another one in a neighboring one of the radiation lines, two bridges are provided both at the first end or both at the second end, electrically connecting the shielded conductor to the exposed conductor of the other radiation line and electrically connecting the exposed conductor to the shielded conductor of the other radiation line, respectively.

14. The radiator according to claim 13, wherein one or both:
the exposed conductor and the shielded conductor of a first one of the radiation lines provide connections for feeding the radiator and/or receiving from the radiator; and
the exposed conductor and the shielded conductor of a last one of the radiation lines are electrically galvanically connected by a shorting contact.

15. The radiator according to claim 1, wherein the radiation lines are arranged on virtual axes in the longitudinal direction, the virtual axes being non-coincident.

16. An antenna, comprising at least one radiator, each radiator comprising:
a plurality of radiation lines, each radiation line comprising a shielded conductor and an exposed conductor;
the shielded conductor and the exposed conductor of each radiation line extending parallel to one another in a longitudinal direction of the radiation line, the exposed conductor surrounding the shielded conductor in a circumferential direction of the radiation line;
the radiation lines being arranged parallel to one another with respect to their longitudinal direction, and having a first end and a second end in the longitudinal direction;
the shielded conductor and the exposed conductor of the same radiation line being electrically insulated from each other at least between the first end and the second end; and
the shielded conductor of one of the radiation lines being electrically connected to the exposed conductor of at least one of the other radiation lines by a bridge.

17. The antenna according to claim 16, wherein the antenna comprises at least two radiators, wherein the longitudinal directions of the radiation lines of the at least two radiators are oriented at an angle, wherein the longitudinal directions of the two radiators are one or both perpendicular to one another and extend in parallel planes.

18. The antenna according to claim 16, wherein a tuning capacitor is connected to connections provided by the radiator, the connections being designed for one or both feeding signals to the radiation lines and receiving signals from the radiation lines

19. A biologically embedded device, a smart device, an electrical magnetic field probe, a wearable or an Internet of Things device, comprising an antenna the device being a device for blood sugar monitoring, a hearing aid, a passport, an ID-badge, a subcutaneous identification chip for animals or humans, a subcutaneous diagnosis device, a swallowable diagnosis device or an electrical magnetic field measuring device, the antenna comprising at least one radiator, each radiator comprising:
a plurality of radiation lines, each radiation line comprising a shielded conductor and an exposed conductor;
the shielded conductor and the exposed conductor of each radiation line extending parallel to one another in a longitudinal direction of the radiation line, the exposed conductor surrounding the shielded conductor in a circumferential direction of the radiation line;
the radiation lines being arranged parallel to one another with respect to their longitudinal direction, and having a first end and a second end in the longitudinal direction;
the shielded conductor and the exposed conductor of the same radiation line being electrically insulated from each other at least between the first end and the second end; and
the shielded conductor of one of the radiation lines being electrically connected to the exposed conductor of at least one of the other radiation lines by a bridge.

20. The radiator according to claim 2, wherein the radiation lines are provided as a cable having an inner conductor and an outer conductor, wherein the inner conductor forms the shielded conductor and the outer conductor forms the exposed conductor.
